(19) United States
(12) Patent Application Publication
(10) Pub. No.: US 2003/0167668 A1
(43) Pub. Date: Sep. 11, 2003

(54) Label application for indicating location of vehicle safety systems

(76) Inventors: Stephen E. Fuks, Ann Arbor, MI (US); Thomas Bernd Krautheim, Belleville, MI (US)

Correspondence Address: BRINKS HOFER GILSON & LIONE, P.O. BOX 10395, CHICAGO, IL, 60611, US

(21) Appl. No.: 10/095,355

(22) Filed: Mar. 11, 2002

(51) Int. Cl. G09F 21/04

(52) U.S. Cl. 40/593

(57) ABSTRACT

A method of indicating to emergency personnel where it is safe on a vehicle to affix equipment or cut the vehicle and where it is not safe to affix of cut so as not to deploy the airbags after a vehicle crash where the airbags did not deploy in the accident.

### BACKGROUND OF THE INVENTION

1. Field of the Invention

The present invention relates to an article and a method to improve safety in a motor vehicle, and in particular, a label indicator to assist emergency personnel after an airbag-equipped vehicle has been involved in an accident.

2. Description of the Prior Art

Air bags are commonly used in motor vehicles to reduce injuries to victims of an automobile accident. For various reasons, airbags do not always deploy during a vehicle impact. This is especially true where a vehicle is equipped with multiple airbags, with groups of airbags dedicated to particular collision types. When emergency personnel are removing victims from a vehicle after an impact, the cutting of vehicle metal and the jostling of the vehicle can accidentally trigger the airbags to deploy, potentially injuring the emergency personnel and further harming the accident victims.

Several methods currently exist to prevent deployment of the airbag when emergency personnel are working around a vehicle. One method is seen in U.S. Pat. No. 6,296,273 issued to Lewallen. This method describes an electronic control device that would enable emergency personnel to deactivate the airbag inflation system. An interrupt switch is located in the circuitry of the vehicle to prevent airbag inflation. The switch would enable emergency personnel to interrupt the electrical communication between the airbag control circuitry and the airbag actuator. This method, however, requires an interrupt circuit to be installed on every vehicle. Emergency personnel would be required to carry a switch control with a transponder and signal source that communicates with the airbag circuitry. This is onerous and unlikely to occur.

The use of a mechanical device restricting the deployment of an airbag from a steering wheel is discussed in U.S. Pat. Nos. 6,322,099 issued to Keeble and 5,997,028 issued to Lenz, herein incorporated by reference. Both of these devices use heavy rigid barriers affixed to a vehicle steering wheel, which thereby obstruct the opening of the steering wheel, thus lessening the danger of inadvertent deployment. These devices are, however, large and heavy and would need to be carried by all emergency personnel. Devices of this nature will take valuable time to install and will offer no protection from the airbag on the passenger side or the side impact airbag.

The need exists for of indicating where it is safe to cut and/or affix to a vehicle after a crash so as not to deploy the airbags and to indicate to emergency personnel where not to affix or cut, also. It is necessary that this indicating method does not interfere with the aesthetics of the vehicle interior. It is therefore a primary object of this invention to provide an aesthetically pleasing method that allows emergency personnel to safely and efficiently remove victims from an airbag-equipped vehicle after an accident where the airbags have not deployed.

### SUMMARY OF THE INVENTION

In accordance with the present invention, these and other objects are accomplished by providing an article and a method for indicating to emergency personnel where it is safe on an airbag-equipped vehicle to affix equipment and cut metal and where it is not safe, without the emergency personnel carrying and/or installing excessive additional equipment to accomplish this purpose.

On a vehicle, there are safe points where emergency equipment may be affixed or the metal cut which will not deploy the airbags. These locations vary from vehicle to vehicle. The present invention is an article and a method of indicating to emergency personnel where on the vehicle they may safely affix or cut to assist accident victims that reduces the risk of accidental unintended airbag deployment and where they should not affix to or cut. The invention encompasses printing information on a label, which is to be placed on the vehicle components, such as the interior trim, the headliner, etc. or printing directly onto the vehicle interior trim component. The information can be printed in a way that it is not visible to the naked eye during normal use of the vehicle, which would interfere with the appearance of the interior of the vehicle. The information would become visible through the use of an ultraviolet light bulb or some other illumination medium.

Additional benefits and advantages of the present invention will become apparent to those skilled in the art to which the present invention relates from the subsequent description of the preferred embodiments and the appended claims, taken in conjunction with the accompanying drawings.

### BRIEF DESCRIPTION OF THE DRAWINGS

FIG. 1 is a perspective view of an embodiment of the present invention;

FIG. 2 is a perspective view of a vehicle interior trim pillar and the attached invention under ultraviolet lighting conditions;

FIG. 3 is a perspective view of a vehicle interior trim pillar and the attached invention under daytime lighting conditions; and

FIG. 4 is a perspective view of an alternate embodiment of the present invention.

### DETAILED DESCRIPTION OF THE PREFERRED EMBODIMENT

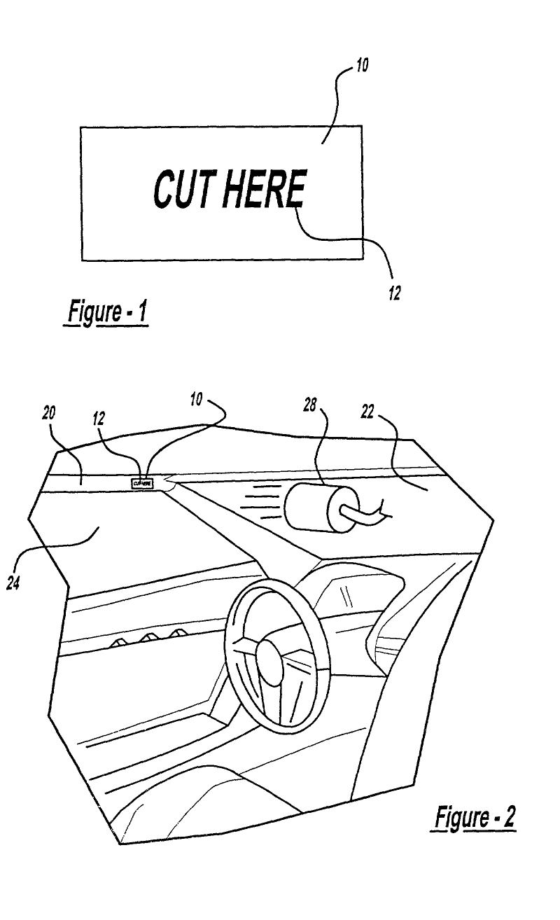

Referring now in detail to the drawings, shown in FIG. 1 is label 10 that is one embodiment of the present invention. Label 10 has printing 12 in a medium not normally visible to the human eye under regular lighting conditions. Printing 12 may recite the phrase “CUT HERE” or “PUSH HERE” or “DO NOT CUT HERE.” However, it is readily apparent to those skilled in the art that many appropriate phrases would apply.

Referring now to FIG. 2, a vehicle roof pillar 20 (the pillar next to the windshield 22 and above the side window 24) is shown. Label 10 is placed on roof pillar 20 in a safe location where emergency personnel can affix equipment to the vehicle or for cutting, if necessary. While roof pillar 20 is used as an example in this embodiment, many other interior surfaces of the vehicle are equally applicable to the use of the present invention. In FIG. 2, label 10 is visible due to the fact that ultraviolet lighting is shone on the interior of the vehicle through lamp 28.

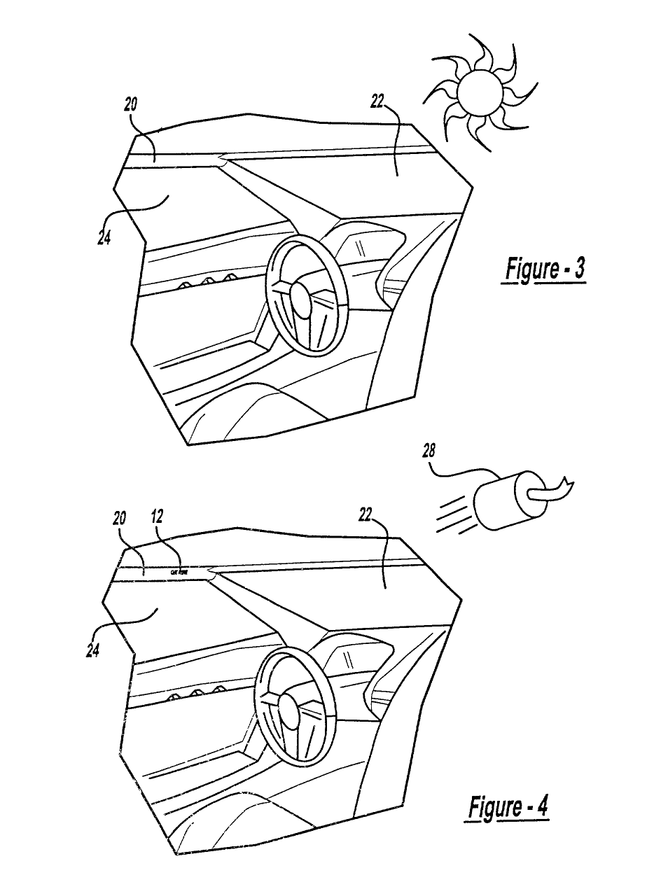

Referring now to FIG. 3, vehicle roof pillar 20 previously seen in FIG. 2 is shown with label 10 affixed to it. Label 10 is not visible in this depiction because only daytime lighting illuminates the vehicle. While not shown, the incandescent lighting of the vehicle interior bulbs would have the same effect of masking the label as daylight illumination. Once the label 10 is illuminated by artificial light of a preselected wavelength band, such as light in the ultraviolet or infrared wavelength range, printing 12 becomes visible. Other optical phenomenon may be used, such a relying on printing 12 polarizing reflected light and viewed through a polarizing analyzer filter. In any event, printing 12 is illuminated and observed in a manner that it detectable, but is not normally visible to the occupants.

In a further embodiment of the present invention as shown in FIG. 4, the label portion of the present invention could be eliminated and the printing 12 placed directly on roof pillar 20. The printing 12 would only be visible when lamp 28 is shown on the roof pillar 20.

While the above description constitutes the preferred embodiments of the present invention, it will be appreciated that the invention is susceptible to modification, variation and change without departing from the proper scope and fair meaning of the accompanying claims.

I claim:

1. An indicator for use in a vehicle to indicate to emergency personnel the locations on the vehicle where it is safe to affix or cut or where it is not safe to affix or cut after an accident so as not to deploy airbags of the vehicle where the vehicle airbags have not deployed comprising:
a printing medium having information visible to emergency personnel when illuminated by artificial light and is not visible during normal operation of the vehicle.

2. The indicator as described in claim 1 further comprising:
a label having a top surface and a back surface;
the printing medium affixed to the label is visible through the top of the label;
an adhesive affixed to the back of the label; and
the label attached to the vehicle by the adhesive to the interior surface of the vehicle.

3. The indicator as described in claim 2 wherein the label is transparent.

4. The indicator as described in claim 1 wherein the printing medium is visible when illuminated by the artificial light in the ultraviolet range.

5. The indicator as described in claim 1 wherein the printing medium is visible when illuminated by the artificial light in the infrared range.

6. The indicator as described in claim 1 wherein the printing medium is visible when seen through a polarizing device.

7. The indicator as described in claim 1 further comprising:
the printing medium printed directly on the interior surface of the vehicle.

8. The indicator as described in claim 7 wherein the printing medium is visible when illuminated by the artificial light in the ultraviolet range.

9. The indicator as described in claim 7 wherein the printing medium is visible when illuminated by the artificial light in the infrared range.

10. The indicator as described in claim 7 wherein the printing medium is visible when seen through a polarizing device.

11. An method of indication for use in a vehicle to indicate to emergency personnel the locations on the vehicle where it is safe to affix or cut or where it is not safe to affix or cut after an accident so as not to deploy airbags of the vehicle where the vehicle airbags have not deployed comprising:
providing a printing medium having information for emergency personnel where the printing medium is not visible during normal operation of the vehicle; and
illuminating by artificial light so the printing medium becomes visible.

12. The method as described in claim 11 further comprising:
providing a label having a top surface and a back surface;
providing the printing medium visible through the top of the label;
providing an adhesive affixed to the back of the label; and
attaching the label to the vehicle by the adhesive to the interior surface of the vehicle.

13. The method as described in claim 12 wherein the label is transparent.

14. The method as described in claim 11 wherein the printing medium is visible when illuminated by the artificial light in the ultraviolet range.

15. The method as described in claim 11 wherein the printing medium is visible when illuminated by the artificial light in the infrared range.

16. The indicator as described in claim 11 wherein the printing medium is visible when seen through a polarizing device.

17. The method as described in claim 1 further comprising:
printing the printing medium printed directly on the interior surface of a vehicle.

18. The method as described in claim 17 wherein the printing medium is visible when illuminated by the artificial light in the ultraviolet range.

19. The method as described in claim 17 wherein the printing medium is visible when illuminated by the artificial light in the infrared range.

20. The method as described in claim 17 wherein the printing medium is visible when seen through a polarizing device.
